(19) United States
(12) Patent Application Publication
(10) Pub. No.: US 2006/0145438 A1
(43) Pub. Date: Jul. 6, 2006

(54) Hat case

(76) Inventor: Nadine L. Plummer, Collierville, TN (US)

Correspondence Address: JAMES RAY & ASSOCIATES, 2640 PITCAIRN ROAD, MONROEVILLE, PA, 15146, US

(21) Appl. No.: 11/286,860

(22) Filed: Nov. 23, 2005

Related U.S. Application Data
(60) Provisional application No. 60/630,955, filed on Nov. 23, 2004.

(51) Int. Cl. B62B 1/00

(52) U.S. Cl. 280/47.26

(57) ABSTRACT

A hat case for holding and transporting one or more hats comprises a first body half having a first elongated semi-cylindrical sidewall extending between a top and bottom portion of the first body half and a second body half having a second elongated semi-cylindrical sidewall extending between a top and bottom portion of the second body half. The first and second sidewalls have first and second longitudinal edges. A hinge assembly is positioned along the first longitudinal edges of the first and second sidewalls for joining the first and second body halves together. A locking assembly is positioned along the second longitudinal edges of the first and second sidewalls for locking the first and second body halves together to form a cylindrical case having an elongated housing for holding and transporting the hats. A plurality of adjustable shelves can be provided within the hat case for transporting a plurality of hats having a variety of shapes and/or sizes.

### CROSS-REFERENCE TO RELATED APPLICATIONS

This application is based on Provisional Application Ser. No. 60/630,955, filed Nov. 23, 2004.

### FIELD OF THE INVENTION

The present invention relates, in general, to a hat case for holding a transporting at least one hat and, more particularly, to a rolling hat case for safely holding and transporting a plurality of hats.

### BACKGROUND OF THE INVENTION

When traveling, space is limited. Placing items under the seat or in an overhead compartment oftentimes causes them to become crushed and mangled, most especially if this item is a hat. Packing hats and/or other delicately shaped articles, in a suitcase with other items is out of the question as it could result in crushing and even ruining of the hat. Thus, the traveler must resort to wearing and/or carrying the hats during travel, greatly reducing the number of head accessories that may be taken when traveling. There is a need in the art for an item that would allow the traveler to safely and conveniently hold and transport a plurality of hats without fear of crushing and/or ruining of the hats.

### OBJECTS OF THE INVENTION

It is therefore an object of the invention to provide a hat case that can safely hold and transport at least one and/or a plurality of hats.

It is a further object of the invention to provide a hat case that is convenient and lightweight.

It is still a further object of the invention to provide a hat case that is rigid so as to prevent damage to the hats.

It is still yet a further object of the invention to provide a hat case that includes a retractable handle/wheel set to facilitate transportation of the case during travel.

It is another object of the invention to provide a hat case that includes cushioned/covered shelves to prevent damage to the hats.

It is a further object of the invention to provide a hat case, which includes adjustable shelves to accommodate hats of varying sizes/shapes.

It is another object of the invention to provide hat cases of varying sizes to accommodate different numbers of hats to be transported by the traveler.

In addition to the various objects and advantages of the invention which have been described in some specific detail above it should be noted that various other objects and advantages of the present invention will become more readily apparent to those persons who are skilled in the relevant art from the following more detailed description, particularly, when such description is taken in conjunction with the attached drawing Figures and with the appended claims.

### SUMMARY OF THE INVENTION

Briefly, and in accordance with the forgoing objectives, the invention comprises a hat case for holding and transporting at least one hat and preferably a plurality of hats. The hat case comprises a first body half having a first predetermined size. This first body half having a top portion, a bottom portion, and a first elongated semi-cylindrical sidewall extending between the top and bottom portion of the first body half. The first elongated semi-cylindrical sidewall having a first and second longitudinal edge. The hat case further comprising a second body half having a second predetermined size, as well as, a top portion, a bottom portion, and a second elongated semi-cylindrical sidewall extending between the top and bottom portion of the second body half. The second elongated semi-cylindrical sidewall also having a first and second longitudinal edge. A hinge assembly is positioned along the first longitudinal edge of the first sidewall of the first body half and the first longitudinal edge of the second sidewall of the second body half for joining the first and second body halves together. A locking assembly is positioned along the second longitudinal edge of the first sidewall of the first body half and the second longitudinal edge of the second sidewall of the second body half for locking the first and second body halves together to form a cylindrical case having a circular top portion, a circular bottom portion, and an elongated housing for holding and transporting at least one hat. A plurality of adjustable shelves can be provided within the hat case for transporting a plurality of hats having a variety of shapes and/or sizes.

### BRIEF DESCRIPTION OF THE DRAWINGS

FIG. 1 shows the hat case of the invention in a closed position having a pull handle in an extended position.

FIG. 2 shows the hat case of the invention wherein the pull handle is in the retracted position.

FIG. 3 shows the hat case of the invention in an open position showing the shelves located therein according to a first embodiment.

FIG. 4 shows the hat case of the invention in an open position showing the shelves located therein according to a second embodiment.

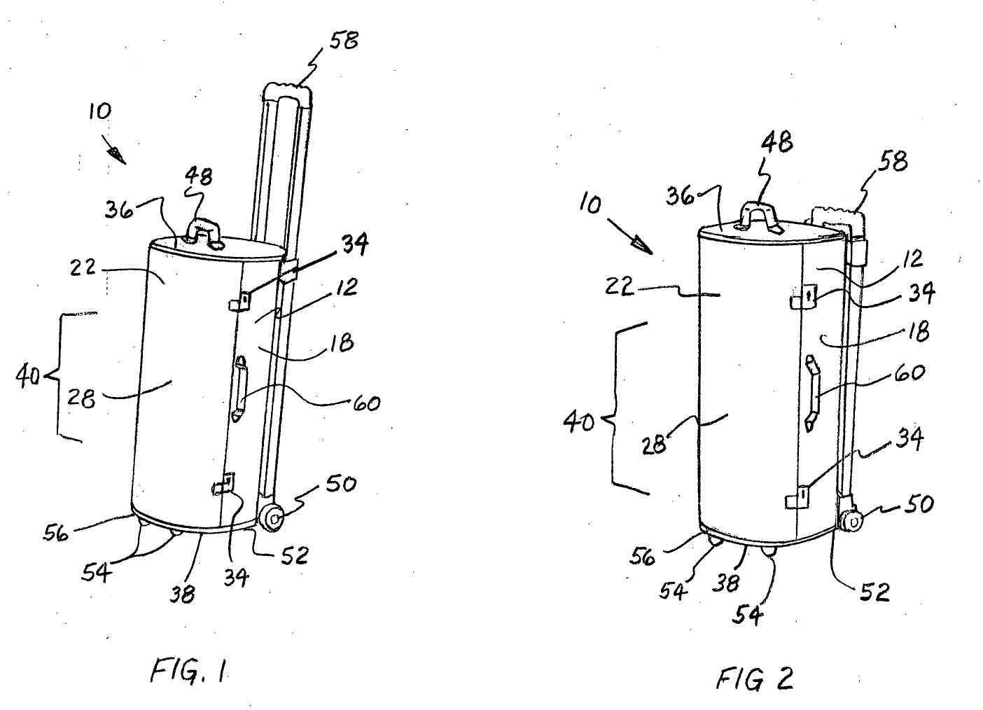

### DETAILED DESCRIPTION OF THE INVENTION

Prior to proceeding to a more detailed description of the invention, it should be noted that identical components having identical functions have been designated with identical reference numerals for the sake of clarity.

Now reference is made to the Figures which show a hat case, generally indicated as 10, for holding and transporting at least one hat and preferably a plurality of hats (not shown). The hat case 10 comprises a first body half 12 having a first predetermined size. This first body half 12 has a top portion 14, a bottom portion 16, and a first elongated semi-cylindrical sidewall 18 extending between the top 14 and bottom 16 portion of the first body half 12. The first elongated semi-cylindrical sidewall 18 having a first 20 and second 21 longitudinal edge. The hat case further comprising a second body half 22 having a second predetermined size. The second body half 22 also includes a top portion 24, a bottom portion 26, and a second elongated semi-cylindrical sidewall 28 extending between the top 24 and bottom 26 portion of the second body half 22. The second elongated semi-cylindrical sidewall 28 also having a first 30 and second 31 longitudinal edge.

The first 12 and second 22 body halves can be substantially symmetrical with each other. Alternatively, the first predetermined size of the first body half 12 can be substantially larger than the second predetermined size of the second body half 22.

The first 12 and second 22 body halves are preferably formed from a rigid material so as to prevent damage to the hat(s). For aesthetic reasons, the first 12 and second 22 body halves can include a soft-sided covering encasing the rigid material.

A hinge assembly 32 is positioned along the first longitudinal edge 20 of the first sidewall 18 of the first body half 12 and the first longitudinal edge 30 of the second sidewall 28 of the second body half 22 for joining the first 18 and second 28 body halves together.

A locking assembly 34 is positioned along the second longitudinal edge 21 of the first sidewall 18 of the first body half 12 and the second longitudinal edge 31 of the second sidewall 28 of the second body half 22 for locking the first 12 and second 22 body halves together to form a cylindrical case having a circular top portion 36, a circular bottom portion 38, and an elongated housing 40 for holding and transporting at least one hat. The locking assembly can be any well-known set of closure devices such as buckles, clips, and the like. An optional key/lock system may be included with the locking assembly to secure the hat case. Preferably, the locking assembly 34 is diametrically opposed to the hinge assembly 32 to enable the cylindrical hat case 10 to be unlocked and opened along the hinge assembly 32.

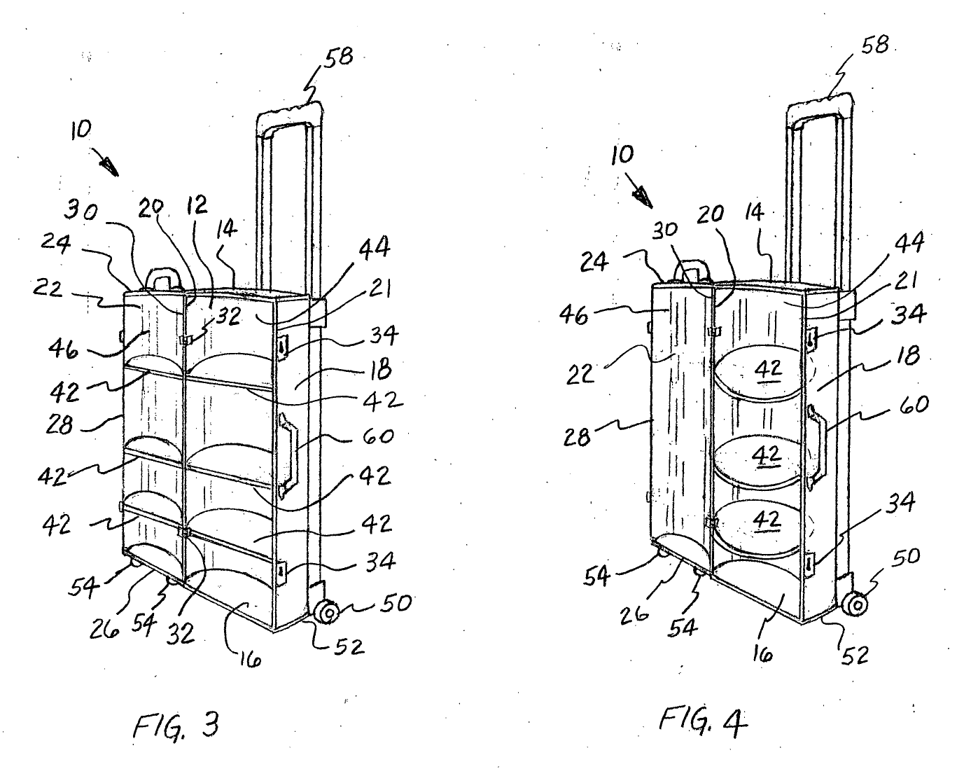

As shown in FIGS. 3-4, the hat case 10 includes at least one shelf 42 positioned along an inner surface 44, 46 of at least one of the first 18 and second 28 sidewalls of the first 12 and second 22 body halves for holding and transporting the hat(s). Preferably a plurality of shelves 42 is provided within the case 10 for holding and transporting a plurality of hats. As shown in FIG. 3, each of the first 12 and second 22 body halves include a portion of the shelves. These shelf portions mate when the case 10 is closed to form a holding surface for the hat(s). Alternatively, as shown in FIG. 4, the first body half 12 can include the entire shelf 42 and the second body half 22 simply closes with the first body half 12 to enclose the hat(s) therein.

The shelves 42 can include padding to cushion the hats during transportation. Any well-known material may be used to provide the padding, such as foam, wadding, and the like. The shelves can further be covered with a soft material such as velvet, felt, and/or any other well-known material. Padding and/or a soft covering may be provided along the inner surfaces 44, 46 of the first 18 and second 28 sidewalls of the first 12 and second 22 body halves.

The shelves 42 may be adjustable along the inner surface 44, 46 of at least one and/or both of the first 18 and second 28 sidewalls so as to accommodate a variety of sizes of hats.

A handle 48 is positioned on the circular top portion 36 of the case 10. A set of wheels 50 is positioned on a first edge portion 52 of the circular bottom portion 38 of the case 10. At least one rubber stand 54 is positioned at a second edge portion 56 of the circular bottom portion 26 of the case 10. This second edge portion 56 is diametrically opposed from the first edge portion 52. A retractable handle 58 is provided for cooperating with the set of wheels 50 for pulling and transporting the case 10.

A handle 60 is positioned along at least one of the second longitudinal edge 21 of the first sidewall 18 of the first body half 12 and the second longitudinal edge 31 of the second sidewall 28 of the second body half 22.

The hat case 10 of the invention is the same size/height as an FDA approved large piece of luggage. The case 10 can be made in a variety of sizes. A large case 10 can hold eight to ten hats. A medium case can hold up to four hats and a carry-on case can hold one to two hats. The carry-on case can be soft-sided luggage. The case of the invention can be used as a carry-on or can be part of checked luggage.

The invention has been described in such full, clear, concise, and exact terms so as to enable any person skilled in the art to which it pertains to make and use the same. It should be understood that variations, modifications, equivalents and substitutions for components of the specifically described embodiments of the invention may be made by those skilled in the art without departing from the spirit and scope of the invention as set forth in the appended claims. Persons who possess such skill will also recognize that the foregoing description is merely illustrative and not intended to limit any of the ensuing claims to any particular narrow interpretation.

I claim:

1. A hat case for holding and transporting at least one hat, said hat case comprising:
(a) a first body half having a first predetermined size, said first body half having a top portion, a bottom portion, and a first elongated semi-cylindrical sidewall extending between said top and bottom portion of said first body half, said first elongated semi-cylindrical sidewall having a first and second longitudinal edge;
(b) a second body half having a second predetermined size, said second body half having a top portion, a bottom portion, and a second elongated semi-cylindrical sidewall extending between said top and bottom portion of said second body half, said second elongated semi-cylindrical sidewall having a first and second longitudinal edge;
(c) a hinge assembly positioned along said first longitudinal edge of said first sidewall of said first body half and said first longitudinal edge of said second sidewall of said second body half for joining said first and second body halves together; and
(d) a locking assembly positioned along said second longitudinal edge of said first sidewall of said first body half and said second longitudinal edge of said second sidewall of said second body half for locking said first and second body halves together to form a cylindrical case having a circular top portion, a circular bottom portion, and an elongated housing for holding and transporting at least one hat.

2. A hat case as recited in claim 1 wherein said locking assembly is diametrically opposed from said hinge assembly to enable said cylindrical case to be unlocked and opened along said hinge assembly.

3. A hat case as recited in claim 1 including at least one shelf positioned along an inner surface of at least one of said first and second sidewalls of said first and second body halves for holding and transporting such at least one hat.

4. A hat case as recited in claim 3 including a plurality of shelves positioned along said inner surface of at least one of said first and second sidewalls of said first and second body halves for holding and transporting a plurality of hats.

5. A hat case as recited in claim 4 wherein said plurality of shelves are cushioned.

6. A hat case as recited in claim 4 wherein said plurality of shelves is covered with a soft material.

7. A hat case as recited in claim 4 wherein said plurality of shelves are adjustable along said inner surface of at least one of said first and second sidewalls so as to accommodate a variety of sizes of hats.

8. A hat case as recited in claim 4 wherein a portion of said plurality of shelves are positioned along said inner surface of each of said first and second sidewalls of said first and second body halves for holding and transporting a plurality of hats.

9. A hat case as recited in claim 1 wherein said first and second body halves are substantially symmetrical with each other.

10. A hat case as recited in claim 1 wherein said first predetermined size of said first body half is substantially larger than said second predetermined size of said second body half.

11. A hat case as recited in claim 1 wherein said first and second body halves are formed from a rigid material.

12. A hat case as recited in claim 11 wherein said first and second body halves include a soft-sided covering encasing said rigid material.

13. A hat case as recited in claim 1 including a handle positioned on said circular top portion of said case.

14. A hat case as recited in claim 1 including a set of wheels positioned on a first edge portion of said circular bottom portion of said case.

15. A hat case as recited in claim 14 including at least one rubber stand positioned at a second edge portion of said circular bottom portion of said case, said second edge portion being diametrically opposed from said first edge portion.

16. A hat case as recited in claim 14 including a retractable handle for cooperating with said set of wheels for pulling and transporting said case.

17. A hat case as recited in claim 1 including a handle positioned along at least one of said second longitudinal edge of said first sidewall of said first body half and said second longitudinal edge of said second sidewall of said second body half.
